(19) United States
(12) Patent Application Publication
(10) Pub. No.: US 2016/0346910 A1
(43) Pub. Date: Dec. 1, 2016

(54) TORQUE TOOL, MOTOR ASSEMBLY, AND METHODS OF USE

(71) Applicant: FORUM ENERGY TECHNOLOGIES (KU) LIMITED, Aberdeen (GB)

(72) Inventor: Stephen WALTON, Aberdeen (GB)

(73) Assignee: Forum Energy Technologies (UK) Limited, Aberdeen (GB)

(21) Appl. No.: 15/116,637

(22) PCT Filed: Feb. 5, 2015
(86) PCT No.: PCT/GB2015/050322

§ 371 Date: Aug. 4, 2016

(30) Foreign Application Priority Data
Feb. 5, 2014 (GB) 1401998.8

(51) Int. Cl. B25B 23/145; E21B 41/04; B25B 21/00

(52) U.S. Cl. CPC B25B 23/145; B25B 21/00; E21B 41/04

(57) ABSTRACT

A torque tool (10) for a subsea vehicle (such as a Remotely Operated Vehicle), a motor assembly (16), and a method of use are described. The torque tool comprises a tool housing, at least one torque drive head, and a drive mechanism operable to rotate the at least one torque drive head. The drive mechanism comprises a first hydraulic motor (17) having a first torque output and a second hydraulic motor (18) having a second torque output. The first and second hydraulic motors are operable to drive a common drive shaft (15). A preferred embodiment comprises a hydraulic motor interface device comprising a first interface surface on one side of the device configured to couple a hydraulic fluid supply to the first motor, and a second interface surface on an opposing side of the device configured to couple a hydraulic fluid supply to the second motor.

The present invention relates to a torque tool motor assembly and method of use, and in particular to a torque tool used in subsea applications for the actuation and operation of subsea equipment. Aspects of the invention relate to torque tools operable by subsea vehicles such as Remotely Operated Vehicles (ROVs).

### BACKGROUND TO THE INVENTION

Subsea torque tools are required to perform a range of tasks on subsea infrastructure and equipment, for example applying torque to actuate rotating components of valves, or to lockdown or release clamps on equipment for the oil and gas industry. Typically, these rotating components are designed to be actuated at a specific torque, and when required to rotate a subsea component, an operator of an ROV torque tool will choose the correct socket size and apply the appropriate torque so that the tool does not impart a torque greater than the maximum capability of the subsea component. The component may fail or become damaged if the torque applied to it by a torque tool is excessive. The retrieval of the subsea component for repair or replacement can be difficult and expensive.

The range of tasks that an ROV torque tool is required to perform means that the torque output of the tool must be changed depending on the torque requirements of the task. The changing of a torque output of the tool has previously been achieved by returning the ROV torque tool to the surface to change out a gearbox and/or change the drive motor of the tool.

More recently, ROV torque tools have been developed in an effort to avoid having to return to the surface and the delays and costs involved in changing the gearbox and/or motor. These tools have a hydraulically-switched gearbox that is capable of generating a range of torque settings. However, these gearboxes are unreliable, having a tendency to lock up during operations. This requires the tool to be returned to the surface for repair resulting in delay and tool repair costs. Another disadvantage of these tools is that they must undergo regular maintenance to prevent damage to the gearbox components.

### SUMMARY OF THE INVENTION

It is an object of an aspect of the present invention to obviate or at least mitigate the foregoing disadvantages of prior art torque tools.

It is another object of an aspect of the present invention to provide a robust, reliable or compact torque tool suitable for deployment subsea, which may be capable of generating a range of torques when deployed subsea.

It is a further object of an aspect of the present invention to provide a torque tool for deployment subsea which has a reduced tendency to lock up during operations.

Further aims of the invention will become apparent from the following description.

According to a first aspect of the invention, there is provided a torque tool comprising:

a tool housing;

at least one torque drive head;

a drive mechanism operable to rotate the at least one torque drive head;

wherein the drive mechanism comprises a first motor having a first torque output and a second motor having a second torque output;

wherein the first and second motors are operable to drive a common drive shaft.

By providing first and second motors, the torque tool may facilitate a range of torque outputs being generated without the need to change a gearbox and/or motor. This may facilitate reliable application of the correct torque to a subsea component. This may also prevent significant delays and costs involved in having to return to the surface to change a gearbox and/or motor when a range of torque outputs are required for a subsea operation.

By providing a subsea torque tool which is capable producing a range of torque outputs the tool may be capable of being utilised in a wide range of tasks. This increases the productivity and efficiency of a subsea operation, or a programme of such operations.

The torque tool may also facilitate the reliable selection of a torque outputs from a range of torque outputs with a reduced tendency to lock up or jam during operations.

The torque tool may be any type of torque tool suitable to apply a torque to a subsea structure or subsea component. Preferably, the torque tool is a torque tool for a subsea vehicle system, which may comprise a Remotely Operated Vehicle, or may comprise an Autonomous Underwater Vehicle (AUV).

The drive head may be any drive head suitable to apply a torque to a rotatable component of a subsea structure or subsea component.

Preferably the first and second motors are hydraulic motors. The hydraulic motors may be selected from the group comprising: gear and vane motors; plunger motors; piston motors or gerotor motors.

Preferably at least one (more preferably each) of the hydraulic motors is a gerotor.

The first torque output and the second torque output may be the same torque value, but preferably the first torque output is different to the second torque output. More preferably the first torque output is lower than the second torque output.

The motors may be operable in a clockwise and/or an anticlockwise direction.

The drive mechanism may be configured to operate the first and second motors in the same direction. Alternately, or in addition, the drive mechanism may be configured to operate the first and second motors in opposing directions.

The drive mechanism may be configured to operate in a low torque mode, in which only the first motor is operated to generate a low torque output.

The drive mechanism may be configured to operate in a medium torque mode, in which only the second motor is operated to generate a medium torque output.

The drive mechanism may be configured to operate in a high torque mode, in which the first and second motors are operated concurrently in the same direction to generate a high torque output.

The drive mechanism may be configured to operate in a super low torque mode, in which the first and second motors are operated concurrently at the same time in opposing directions to generate a super low torque output.

The drive mechanism may comprise a hydraulic motor interface device comprising a first interface surface on one side of the device configured to couple a hydraulic fluid supply to the first motor, and a second interface surface on an opposing side of the device configured to couple a hydraulic fluid supply to the second motor.

The first and/or second interface surfaces may comprise one or more grooves to fluidly couple with the first and/or second hydraulic motors.

The hydraulic motor interface device may comprise a plurality of radial ports fluidly connected with one or more grooves to fluidly couple with the first and/or second hydraulic motors.

Preferably the common drive shaft extends through the hydraulic motor interface device.

The drive mechanism may comprise at least one transfer plate configured to control the flow of hydraulic fluid into and out from the motors. Preferably the drive mechanism may comprise a transfer plate located between the hydraulic motor interface device and each motor.

The or each transfer plate may comprise an inner arrangement of channels and/or an outer arrangement of channels. The inner arrangement of channels and/or an outer arrangement of channels may comprise rings. The transfer plate may be configured such that hydraulic fluid enters the motor via the inner arrangement of channels and exits the motor via the outer arrangement of channels. Alternatively, or in addition, the transfer plate is configured such that hydraulic fluid enters the motor via the outer arrangement of channels and exits the motor via the inner arrangement of channels.

The common drive shaft may extend through the hydraulic motor interface device.

Preferably the common drive shaft extends through the or each transfer plate.

The torque tool may comprise a drainage path for at least one of the first or second hydraulic motors. The drainage path may be configured to enable hydraulic fluid from a disengaged hydraulic motor to be drained when the other of the hydraulic motors is operable. This may prevent a disengaged motor from acting as a pump during operation of the operating motor and rotation of the common drive shaft.

The hydraulic motor interface device may comprise a drain port. The first and/or second interface surfaces on the motor interface device may comprise one or more drainage grooves or channels which may be in fluid communication with the drain port.

The torque tool may comprise a pilot relief manifold block. The pilot relief block may control the drainage of the hydraulic fluid from a disengaged motor to a hydraulic return line.

The pilot relief block may control the drainage of the hydraulic fluid from a disengaged motor via the drain port to a hydraulic return line.

According to a second aspect of the invention, there is provided a torque tool comprising:

a tool housing;

at least one torque drive head;

a drive mechanism operable to rotate the at least one torque drive head;

wherein the drive mechanism comprises a first hydraulic motor having a first torque output and a second hydraulic motor having a second torque output;

wherein the first and second hydraulic motors are operable to drive a common drive shaft;

and wherein the drive mechanism further comprises an hydraulic motor interface device comprising a first interface surface on one side of the device configured to couple a hydraulic fluid supply to the first motor, and a second interface surface on an opposing side of the device configured to couple a hydraulic fluid supply to the second motor.

Preferably the first and/or second interface surface is substantially planar.

The first and/or second interface surface may comprise one or more grooves to fluidly couple with the first and/or second hydraulic motors.

Preferably the hydraulic motor interface device comprises a plurality of radial ports fluidly connected with one or more grooves to fluidly couple with the first and/or second hydraulic motors.

Preferably the common drive shaft extends through the hydraulic motor interface device.

The hydraulic motor interface device may have an axial dimension in the direction of the drive shaft of less than approximately 100 mm, and more preferably less than approximately 80 mm. In an embodiment of the invention the hydraulic motor interface device has an axial dimension in the direction of the drive shaft of less than approximately 60 mm, and more preferably less than approximately 40 mm.

Embodiments of the second aspect of the invention may include one or more features of the first aspect of the invention or its embodiments, or vice versa.

According to a third aspect of the invention, there is provided a torque tool comprising:

a tool housing;

at least one torque drive head;

a drive mechanism operable to rotate the at least one torque drive head;

wherein the drive mechanism comprises a first hydraulic motor having a first torque output and a second hydraulic motor having a second torque output;

wherein the first and second hydraulic motors are operable to drive a common drive shaft;

wherein the torque tool further comprises a drainage path for at least one of the first or second hydraulic motors, the drainage path configured to enable hydraulic fluid from a hydraulic motor to be drained when the other of the hydraulic motors is operable to drive the common shaft.

The torque tool may facilitate hydraulic fluid from a disengaged hydraulic motor to be drained when the other of the hydraulic motors is operable. This may prevent a disengaged motor acting as a pump during operation of the operating motor and rotation of the common drive shaft.

The torque tool may comprise a drain port. The drain port may be in fluid communication with the drainage path.

The torque tool may comprise a pilot relief manifold block. The pilot relief block may control the drainage of the hydraulic fluid from a hydraulic motor to a hydraulic return line via the drainage path.

The pilot relief block may control the drainage of the hydraulic fluid from a hydraulic motor via the drain port to a hydraulic return line.

Embodiments of the third aspect of the invention may include one or more features of the first or second aspects of the invention or their embodiments, or vice versa.

According to a fourth aspect of the invention, there is provided a torque tool comprising:

a tool housing;

at least one torque drive head;

a drive mechanism operable to rotate the at least one torque drive head;

wherein the drive mechanism comprises a first hydraulic motor having a first torque output and a second hydraulic motor having a second torque output;

wherein the first and second hydraulic motors are operable to drive a common drive shaft;

wherein the drive mechanism further comprises an hydraulic motor interface device comprising a first interface surface on one side of the device configured to couple a hydraulic fluid supply to the first motor, and a second interface surface on an opposing side of the device configured to couple a hydraulic fluid supply to the second motor;

and wherein the common drive shaft extends through the hydraulic motor interface device.

Embodiments of the fourth aspect of the invention may include one or more features of the first to third aspects of the invention or their embodiments, or vice versa.

According to a fifth aspect of the invention, there is provided a motor assembly for a torque tool, the motor assembly comprising a first hydraulic motor having a first torque output and a second hydraulic motor having a second torque output;

wherein the first and second hydraulic motors are operable to drive a common drive shaft.

The motor assembly may facilitate improved productivity performance and efficiency of subsea operations as it may be capable of performing a wide range of tasks once deployed subsea.

By providing a motor assembly having different torque outputs, a range of tasks each with a different torque output requirement can be performed without significant time delays and costs involved in having to return to the surface to change a gearbox and/or motor.

The motor assembly may also facilitate the reliable selection of a torque output from a range of torque outputs with a reduced tendency to lock up or jam during operations.

The torque tool may be any type of torque tool suitable to apply a torque to a subsea structure component. Preferably, the torque tool is a torque tool for a subsea vehicle system, which may comprise a Remotely Operated Vehicle, or may comprise an Autonomous Underwater Vehicle (AUV).

The drive head may be any drive head suitable to apply a torque to a rotatable component of a subsea structure.

Preferably the first and second motors are hydraulic motors. The hydraulic motors may be selected from the group comprising gear and vane motors, plunger motors, piston motors or gerotor motors. Preferably at least one (more preferably each of) the hydraulic motors is a gerotor.

Embodiments of the fifth aspect of the invention may include one or more features of the first to fourth aspects of the invention or their embodiments, or vice versa.

According to a sixth aspect of the invention there is provided a method of operating a torque tool or motor assembly according to a previous aspect of the invention.

Embodiments of the sixth aspect of the invention may include one or more features of the first to fifth aspects of the invention or their embodiments, or vice versa.

According to a seventh aspect of the invention, there is provided a method of performing a subsea operation, the method comprising:

providing a torque tool at a subsea location, the torque tool comprising at least one torque drive head; and a drive mechanism operable to rotate the at least one torque drive head, wherein the drive mechanism comprises a first motor and a second motor;

driving a drive shaft in a first mode of operation, in which the first motor is operated to drive the drive shaft with a first torque output;

driving the drive shaft in a second mode of operation, in which the second motor is operated to drive the drive shaft with a second torque output.

The first torque output and the second torque output may be the same torque value.

Preferably, the first torque output and the second torque output are different torque values. More preferably the first torque output is lower than the second torque output.

The method may comprise operating the motors in a clockwise direction and/or an anticlockwise direction.

The method may comprise operating the drive mechanism in a low torque mode, in which only the first motor is operated to generate a low torque output.

The method may comprise operating the drive mechanism in a medium torque mode, in which only the second motor is operated to generate a medium torque output.

The method may comprise operating the drive mechanism in a high torque mode, in which the first and second motors are operated concurrently in the same direction to generate a high torque output.

The method may comprise operating the drive mechanism in a super low torque mode, in which the first and second motors are operated concurrently at the same time in opposing directions to generate a super low torque output.

The first and second motors may be hydraulic motors.

The method may comprise draining hydraulic fluid from a disengaged hydraulic motor to when the other of the hydraulic motors is operable. The method may comprise draining the hydraulic fluid from a de-activated hydraulic motor when the other hydraulic motor is activated. This may prevent the disengaged motor acting as a pump during operation of the operating motor and rotation of the common drive shaft.

Embodiments of the seventh aspect of the invention may include one or more features of the first to sixth aspects of the invention or their embodiments, or vice versa.

According to an eighth aspect of the invention, there is provided a method of operating a torque tool comprising:

providing a torque tool, the torque tool comprising at least one torque drive head and a drive mechanism operable to rotate the at least one torque drive head; and a first motor having a first torque output and a second motor having a second torque output;

activating the first and/or second motors to drive a common drive shaft.

The method may comprise activating the first and/or second motor to rotate in a clockwise direction and/or an anticlockwise direction.

The method may comprise operating the first and second motors to rotate in the same direction. Alternatively, the method may comprise operating the first and second motors to rotate in opposing directions.

The method may comprise operating the drive mechanism in a low torque mode, in which only the first motor is operated to generate a low torque output.

The method may comprise operating the drive mechanism in a medium torque mode, in which only the second motor is operated to generate a medium torque output.

The method may comprise operating the drive mechanism in a high torque mode, in which the first and second motors are operated concurrently in the same direction to generate a high torque output.

The method may comprise operating the drive mechanism in a super low torque mode, in which the first and second motors are operated concurrently at the same time in opposing directions to generate a super low torque output.

The first and second motors may be hydraulic motors. The hydraulic motors may be selected from the group comprising gear and vane motors, plunger motors, piston motors or gerotor motors. Preferably, at least one (more preferably each) of the hydraulic motors is a gerotor.

The method may comprise draining the hydraulic fluid from at least one of the first or second hydraulic motors. The method may comprise draining the hydraulic fluid from a de-activated hydraulic motor when the other hydraulic motor is activated. This may prevent the de-activated motor acting as a pump during operation of the activated motor and rotation of the common drive shaft.

Embodiments of the eighth aspect of the invention may include one or more features of the first to seventh aspects of the invention or their embodiments, or vice versa.

According to a ninth aspect of the invention there is provided a subsea vehicle system comprising a torque tool according to any of the first to fourth aspects of the invention.

Preferably, the subsea vehicle is a Remote Operated Vehicle (ROV).

Embodiments of the ninth aspect of the invention may include one or more features of the first to eighth aspects of the invention or their embodiments, or vice versa.

According to a ninth aspect of the invention there is provided a subsea vehicle comprising a motor assembly according to the fifth aspect of the invention.

Preferably, the subsea vehicle is a Remote Operated Vehicle (ROV).

Embodiments of the tenth aspect of the invention may include one or more features of the first to tenth aspects of the invention or their embodiments, or vice versa.

According to further aspects of the invention, there is provided torque tools, motor assemblies for a torque tool and ROV apparatus substantially as herein described with reference to the appended drawings.

### BRIEF DESCRIPTION OF THE DRAWINGS

There will now be described, by way of example only, various embodiments of the invention with reference to the drawings, of which:

FIGS. 1A, 1B and 1C are forward, plan and side views of a torque tool according to a first embodiment of the invention;

FIGS. 2A and 2B are first and second isometric views of the assembled dual motor of the torque tool of FIGS. 1A, 1B and 1C;

FIG. 3 is a schematic cross-section view of an assembled dual motor of the torque tool of FIGS. 1A, 1B and 1C;

FIG. 4 is a side view of a first motor of the torque tool of FIGS. 1A, 1B and 1C;

FIG. 5 is a side view of a second motor of the torque tool of FIGS. 1A, 1B and 1C;

FIGS. 6A and 6B are schematic front and back views of a motor port plate of the torque tool of FIGS. 1A, 1B and 1C.

FIGS. 7A, 7B and 7C show schematically a motor port plate of the torque tool of FIGS. 1A, 1B and 1C in lower, side, and plan views respectively;

FIG. 8 shows schematically a side cross-section of a motor port plate of the torque tool FIGS. 1A, 1B and 1C; and

FIG. 9 shows schematically a side cross-section of a port section of a motor port plate FIGS. 1A, 1B and 1C.

### DETAILED DESCRIPTION OF PREFERRED EMBODIMENTS

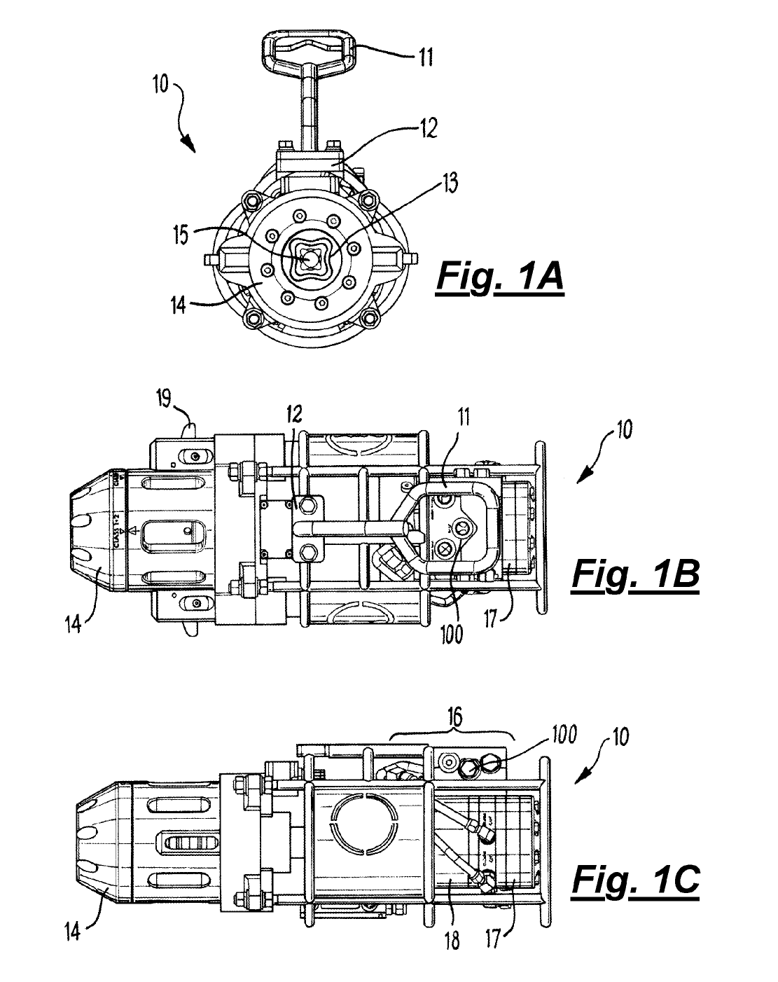

Referring firstly to FIGS. 1A, 1B and 1C, there is shown a torque tool 10 according to a first embodiment of the invention, shown from front, plan and side views respectively. The tool 10 is configured to apply a torque to a rotatable component of a subsea structure. The tool 10 has a handle 11 attached to a main body 12. At one end of the tool 10 is a rotatable socket assembly 13 surrounded by a nose cone 14. A socket assembly 13 is connected to a drive shaft 15, which is driven by a dual range motor assembly 16 comprising two gerotor motors 17 and 18.

In use, the socket assembly 13 engages with a rotatable component of a subsea structure. Wing members 19 engage the subsea structure to hold the tool onto the interface and lock the tool in position. The two gerotor motors 17 and 18 generate an output torque which is transferred to the socket assembly 13 by the drive shaft 15, which extends from the first gerotor motor 17 through the second gerotor motor 18 to the socket assembly 13.

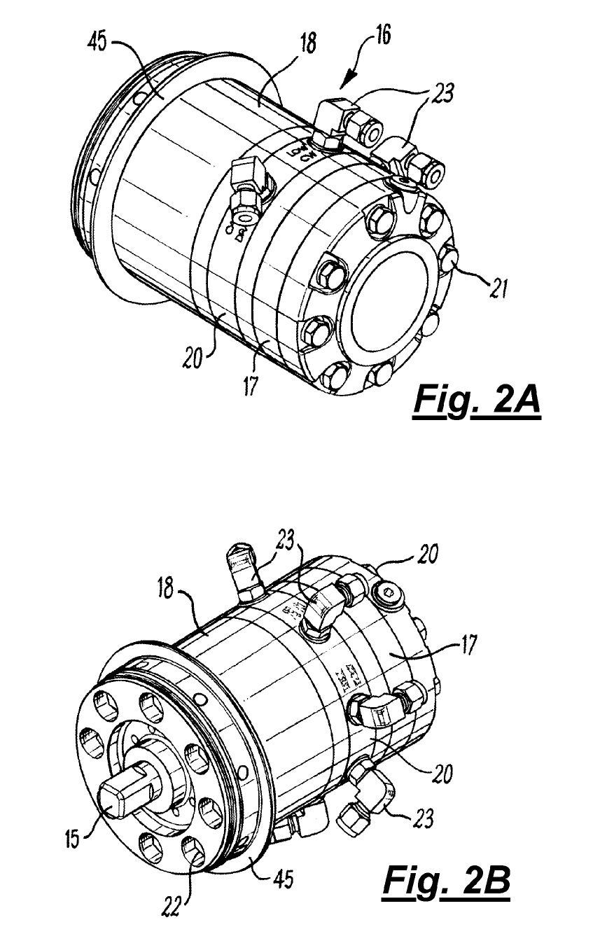

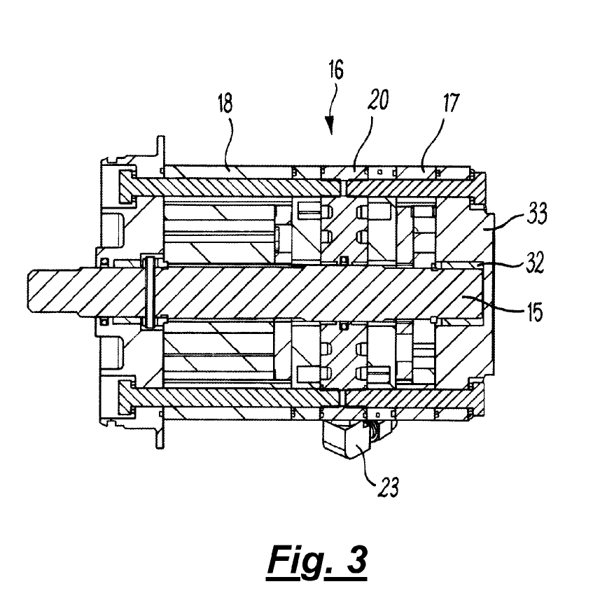

FIGS. 2A and 2B are respectively first and second isometric views of the dual motor assembly 16 of the torque tool 10, shown isolated from the tool, and FIG. 3 is a schematic cross-sectional view of the dual motor assembly. The dual motor 16 comprises a first gerotor motor 17 connected to a second gerotor motor 18 via a motor port plate 20. Mounting bolts 21 extend along the first gerotor motor 17, and engage with motor port plate 20 to attach the first gerotor motor 17 to motor port plate 20. Mounting bolts 22 extend along a motor mounting plate 45 through the second gerotor motor 18, and engage with motor port plate 20 to attach the second gerotor motor 18 to motor port plate 20.

The motor port plate 20 has hydraulic fluid ports 23 around its peripheral edge. The hydraulic fluid ports are operable to be connected to a hydraulic fluid pressure system. In use, hydraulic fluid is pumped into one or more of the ports 23 to exert pressure on the rotors (not shown) of the gerotor motors 17 and 18 to induce rotation of the rotors and in turn rotate the drive shaft 15.

As most clearly shown in FIG. 3, the drive shaft 15 extends from a drive shaft bush 32 located in end cap 33 of the first gerotor motor 17, through motor port plate 20 and the second gerotor motor 18 to the socket assembly (not shown). The motor port plate 20 has hydraulic fluid ports located around its peripheral edge 23 (only one is shown).

In use, hydraulic fluid enters the motor port plate 20 via at least one of the hydraulic fluid ports 23. Depending on which port or ports the hydraulic fluids enters, the first gerotor motor 17, the second gerotor motor 18, or a combination of both motors is engaged. The selection of the port or ports 23 used also determines the manner in which the hydraulic fluid flows within the first gerotor motor 17, the second gerotor motor 18 or a combination of the motors, and enables the direction of rotation of the drive shaft 15 to be selected and controlled. This will be described in more detail below.

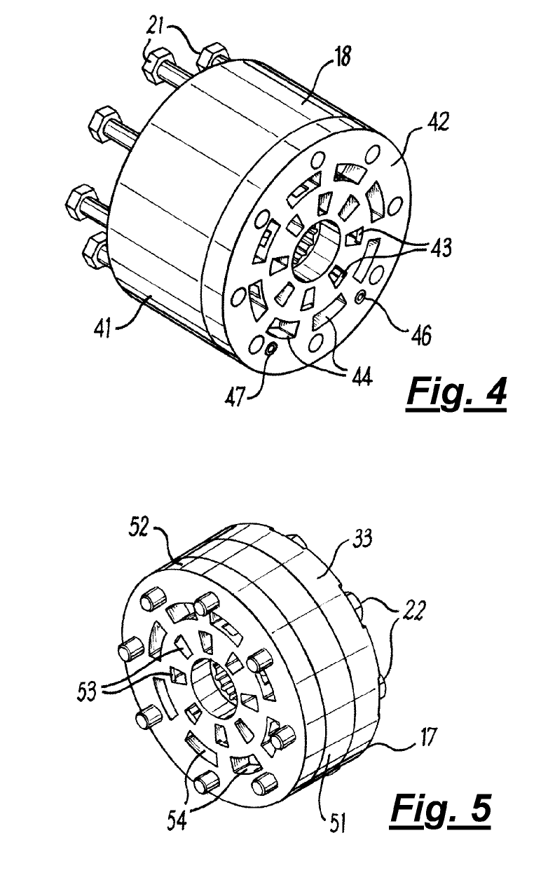

FIG. 4 is a side view of the second gerotor motor 18 of the torque tool 10. The second gerotor motor 18 has an outer casing 41 connected to a port transfer plate 42. The outer casing 41 houses the gerotor motor components of the second gerotor motor.

The port transfer plate 42 is connectable to motor port plate 20 by mounting bolts 22 which extend along the second gerotor motor 18. The port transfer plate 42 has an inner ring of channels 43 and outer ring of channels 44. The inner and outer rings allow hydraulic fluid to enter and exit the second gerotor motor. By controlling which ring of channels the hydraulic fluid flows into or out of the second gerotor motor 18, the direction of rotation of the motor 18 (and therefore the direction of rotation of the driveshaft 15) can be controlled.

FIG. 5 is a side view of the first gerotor motor 17 of the torque tool 10. The first gerotor motor 17 has mounting bolts 21 which extend through an end cap 33, outer casing 51 and port transfer plate 52. The outer casing 51 houses the gerotor motor components of the first gerotor motor. The port transfer plate 52 is connectable to motor port plate 20 by mounting bolts 21. The port transfer plate 52 has an inner ring of channels 53 and outer ring of channels 54. The inner ring 53 and the outer ring 53 and 54 allow hydraulic fluid to enter and exit the first gerotor motor. By controlling which ring of channels 53 or 54 the hydraulic fluid flows into or out of the first gerotor motor 17, the direction of rotation of the motor 17 (and therefore the direction of rotation of the driveshaft can be controlled.

The first gerotor motor 17 may contain ball bearings (not shown) within movable within channels in the outer casing 51. Once a specific hydraulic pressure has been reached, the ball bearings are forced along the channel toward the end cap 33, sealing the channel and sealing the pressure in the first gerotor motor 17, forcing the gerotor to rotate.

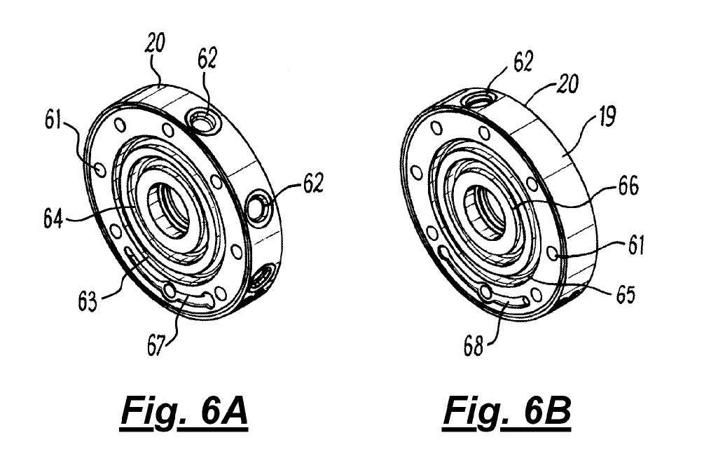

FIGS. 6A and 6B are schematic front and back isometric views of a motor port plate 20 of the torque tool 10. The motor port plate 20 has bolt holes 61 on both sides of the plate. The bolt holes 61 on one side of the motor port plate 20 engage mounting bolts 21 to secure it to the first gerotor motor. The bolts holes 61 on the other side of the motor port plate 20 engage mounting bolts 22 and secure it to the second gerotor motor. Around the periphery of the motor port plate 20 are hydraulic fluid ports 62 which are configured to engage a hydraulic fluid system. On both sides of the motor port plate 20 are located grooved rings 63, 64, 65 and 66. Drainage grooves 67 and 68 are located on both sides of the motor port plate.

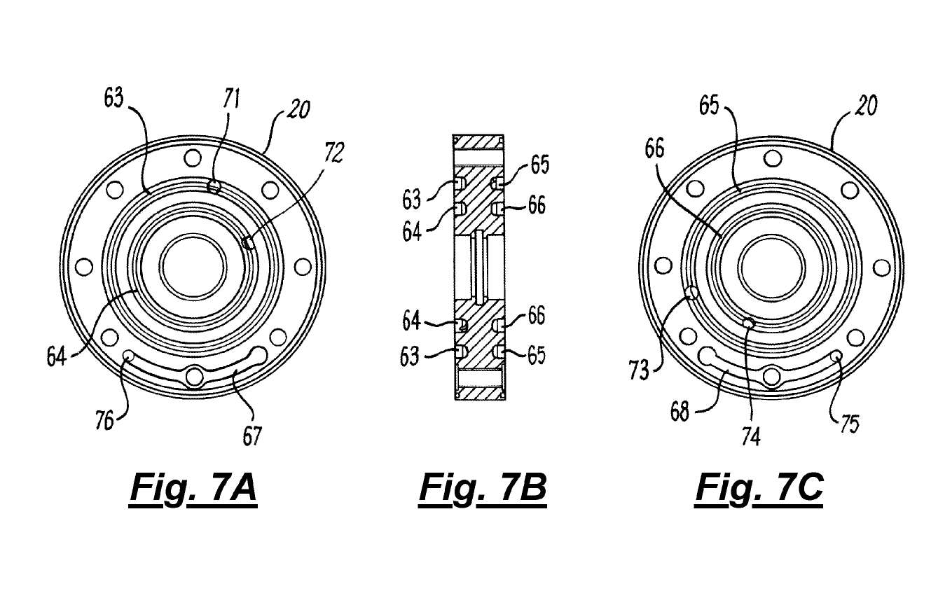

FIGS. 7A, 7B and 7C show schematically a motor port plate 20 of the torque tool 10 in lower, side, and plan views respectively. The motor port plate 20 has two groove holes 71 and 72, located within the grooves 63 and 64 on a first side of the motor port plate 20 and two groove holes 73 and 74 located within the grooves 65 and 66 on a second side of the motor port plate 20. Each of the groove holes 71, 72, 73 and 74 are configured to be in fluid communication with a respective port 81, 82, 83 and 84 located on the peripheral edge of motor port plate 20 The motor port plate 20 also has drainage groove hole 75 located in a drainage groove 68 on one side of the motor port plate 20, and a second drainage groove hole 76 located in a drainage groove 67 on the other side of the motor port plate 20. The groove holes 75 and 76 are configured to be in fluid communication with drainage port 85. The drainage grooves 67 and 68 and their respective drainage holes 75 and 76 are designed to interact with to drain any oil that has leaked or egressed.

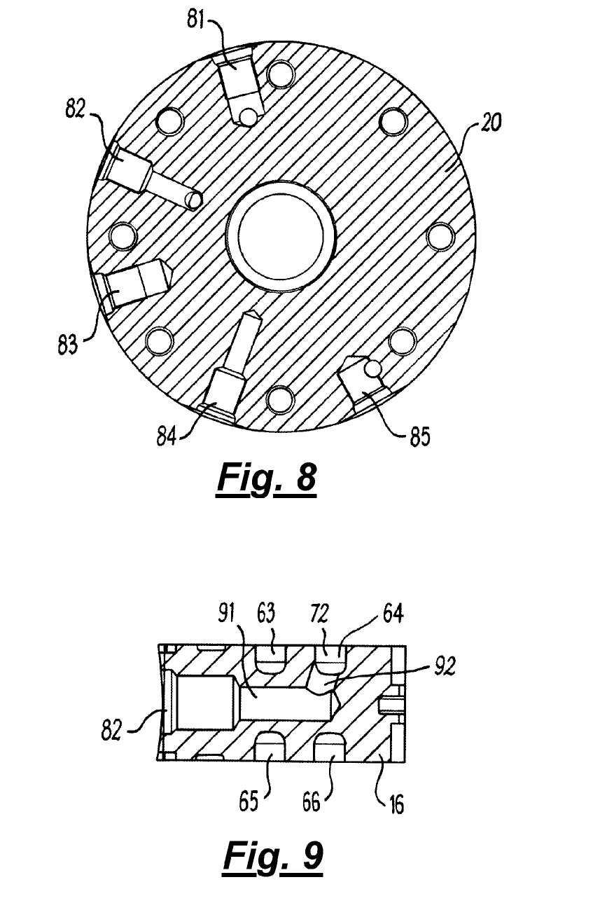

FIG. 8 shows schematically a side cross-section of a motor port plate 20 of the torque tool 10. The motor port plate 20 has five ports 81, 82, 83, 84 and 85 arranged along its peripheral edge. The ports 81, 82, 83, 84 are configured to engage a hydraulic fluid system (not shown). Port 85 is configured to engage a drainage system. Each port 81, 82, 83, 84 and 85 extends downward through the edge of motor port plate 20. The depth to which ports 81 and 82 extend corresponds with the location of the groove holes 71 and 72 on a first side of the motor port plate 20. The depth to which ports 83 and 84 extend corresponds with the location of the groove holes 73 and 74 on a first side of the motor port plate 20. The depth to which port 85 extends corresponds with the location of the drainage groove holes 75 and 76.

FIG. 9 shows schematically a cross-section of a port section of the motor port plate 20. The port 82 extends downwards through the edge of motor port plate 20 into a channel 91. A smaller side channel 92 connects the channel 91 and the groove hole 72 located in groove 64 on one surface of the motor port plate 20. The groove 63 on one surface of the motor port plate 19 and the grooves 65 and 66 remain isolated from the channels 91 and 92. Similar arrangements exist between port 81 and groove hole 71, port 83 and groove 73 and port 84 and groove hole 74 and port 85 and groove holes 85 and 86 (not shown). Grooves 63 and 64 supply the first gerotor motor 17 with hydraulic fluid. Similarly, grooves 65 and 66 supply the second gerotor motor 17 with hydraulic fluid.

The gerotor motors 17 and 18, and in particular their port transfer plates 52 and 42, may be configured such that the inward flow of hydraulic fluid through either the inner ring of channels 53 and 43 or the outer ring of channels 54 and 44 results in the clockwise or anticlockwise rotation of the driveshaft 15.

In use, a hydraulic fluid system is attached to ports 81, 82, 83, 84 and a drainage system is attached to port 85. Hydraulic fluid is pumped into the motor port plate 20. Depending on which port the hydraulic fluid is pumped into, the groove (or which combination of grooves) 63, 64, 65, or 66 in which the fluid flows is selected, along with direction the hydraulic fluid flows in the groove.

For a high torque application in a clockwise direction, the hydraulic lines connected to ports 82 and 84 are activated. This provides pressurised hydraulic fluid through holes 72 and 74 and around grooves 64 and 66 on either side of the motor port plate 20. The hydraulic fluid flows through the inner ring of channels 53 of port transfer plate 52 and enters the first gerotor motor 17. Hydraulic fluid also flows through the inner ring of channel 43 of port transfer plate 42 and enters the second gerotor motor 18.

The fluid exerts pressure on the rotors (not shown) of the gerotor motors 17 and 18 to induce rotation of the rotors which in turn rotates drive shaft 15 in a clockwise direction. The fluid exits the first gerotor motor 17 by flowing through the outer ring of channels 54 of port transfer plate 52 and through the hole 71 in groove 63 and through port 81 to the hydraulic system. The fluid exits the second gerotor motor 18 by flowing through the outer ring of channels 44 of port transfer plate 42 and through groove hole 73 in groove 65 of the motor port plate 20 through port 83 to the hydraulic system.

As the gerotor motor components are all metal-on-metal face seals, there will generally tend to be some degree of hydraulic fluid leakage. Any hydraulic fluid leakage in the first gerotor motor 17 collects around a groove (not shown) in the outer casing 51. This groove also collects leaking hydraulic fluid from bolt holes holding mounting bolts 22. The collected hydraulic fluid is passed through a cross drilling to a port (not shown) on the end cap 33.

Leaking hydraulic fluid in the second gerotor motor 18 flows along a groove (not shown) in the outer casing 41 of the second gerotor motor 18. This groove also collects leaking hydraulic fluid from bolt holes holding mounting bolts 21. The collected hydraulic fluid then flows down the two drain lines (not shown) towards port transfer plate 42. The hydraulic fluid passes through the channels 46 and 47 in the port transfer plate 42. The channels 46 and 47 align with the drainage groove 68 on the motor port plate 20. The collected hydraulic fluid is then drained through drainage groove hole 75 located in drainage groove 68 and out through drainage port 85.

To achieve high torque generation and application in a counter-clockwise direction, the hydraulic fluid enters the tool via ports 81 and 83 and exits back into the hydraulic system by ports 82 and 84, effectively reversing the clockwise procedure.

For a medium torque application in a clockwise direction, only the second gerotor motor 18 is engaged. The hydraulic line connected to ports 84 is activated. This provides pressurised hydraulic fluid through holes 74 and around groove 66 on one side of the motor port plate 20. The hydraulic fluid flows through the inner ring of channel 43 of port transfer plate 42 and enters the second gerotor motor 18.

The fluid exerts pressure on the rotors (not shown) of the second gerotor motor 18 to induce rotation of the rotor which in turn rotates drive shaft 15 in a clockwise direction. The fluid exits the second gerotor motor 18 by flowing through the outer ring of channels 44 of port transfer plate 42 and through groove hole 73 in groove 65 of the motor port plate 20 through port 83 to the hydraulic system.

To achieve medium torque application in a counter-clockwise direction the hydraulic fluid enters the tool via ports 83 and exits back into the hydraulic system by port 84, effectively reversing the clockwise procedure.

For low torque applications in a clockwise direction, only the first gerotor motor 17 only is engaged. The hydraulic line connected to port 82 is activated. This provides pressurised hydraulic fluid through hole 72 and around groove 64 on the motor port plate 20. The hydraulic fluid flows through the inner ring of channel 53 of port transfer plate 52 and enters the first gerotor motor 17. The fluid exerts pressure on the rotor (not shown) of the gerotor motors 17 to induce rotation of the rotors which in turn rotates drive shaft 15 in a clockwise direction. The fluid exits the first gerotor motor 17 by flowing through the outer ring of channels 54 of port transfer plate 52, through port 81 to the hydraulic system

To prevent the disengaged second gerotor from acting as a pump during rotation of the drive shaft, a pilot relief manifold block 100 is activated. The pilot relief manifold block 100 is connected to the drainage port 85 located on the peripheral edge of motor port plate 20. The pilot relief manifold block 100 drains any hydraulic fluid present in the second gerotor motor 18 through drainage hole 75 on motor port plate 20. The fluid passed through drainage hole 75 to port 85 and into the hydraulic return line.

To achieve low torque application in a counter clockwise direction the hydraulic fluid enters the tool via ports 81 and exits back into the hydraulic system by port 82 effectively reversing the clockwise procedure.

For super low torque applications the first gerotor motor 17 may be operated in a first direction as described above and the second gerotor motor 18 may be operated in the opposing direction. The torque applied by the first motor acts against the torque applied by the second motor, to reduce the torque output to the shaft to the difference between the respective torques.

Although the embodiments of the invention described herein a dual motor configurations, it will be appreciated that the principles of the invention may be applied to torque tools with a greater number of motors. Some of the motors may have differing torque outputs, such that a range of torque outputs can be provided when the motors are run separately or in combination (in subsets or all together) in the same or opposing directions to one another.

The present invention provides a torque tool, a motor assembly, and a method of use. The torque tool comprises a tool housing, at least one torque drive head, and a drive mechanism operable to rotate the at least one torque drive head. The drive mechanism comprises a first hydraulic motor having a first torque output and a second hydraulic motor having a second torque output. The first and second hydraulic motors are operable to drive a common drive shaft. A preferred embodiment comprises an hydraulic motor interface device comprising a first interface surface on one side of the device configured to couple a hydraulic fluid supply to the first motor, and a second interface surface on an opposing side of the device configured to couple a hydraulic fluid supply to the second motor.

The invention obviates or at least mitigates disadvantages of prior art torque tools, by providing a robust, reliable and compact torque tool suitable for deployment subsea and which is capable of generating a range of torques when deployed subsea. Torque tools of embodiments of the invention may have a reduced tendency to lock up during operations.

Various modifications to the above described embodiments may be made within the scope of the invention herein intended.

1. A torque tool comprising a tool housing;
at least one torque drive head; and
a drive mechanism operable to rotate the at least one torque drive head;
wherein the drive mechanism comprises a first motor having a first torque output and a second motor having a second torque output;
wherein the first and second motors are operable to drive a common drive shaft.

2. The torque tool according to claim 1, wherein the first and second motors are hydraulic motors.

3. The torque tool according to claim 1, wherein the first and second motors are gerotors.

4. The torque tool according to claim 1, wherein the first torque output and the second torque output have different torque values.

5.-6. (canceled)

7. The torque tool according to claim 1, wherein the drive mechanism is configured to operate the first and second motors in the same direction.

8. The torque tool according to claim 1, wherein the drive mechanism is configured to operate the first and second motors in opposing directions.

9. The torque tool according to claim 1, wherein the drive mechanism is configured to selectively operate only the first motor; only the second motor; or operate both motors simultaneously.

10. The torque tool according to claim 1, wherein the first torque output is lower than the second torque output, and wherein the drive mechanism is configured to operate in a low torque mode, in which only the first motor is operated to generate a low torque output.

11. The torque tool according to claim 1, wherein the first torque output is lower than the second torque output, and wherein the drive mechanism is configured to operate in a medium torque mode, in which only the second motor is operated to generate a medium torque output.

12. The torque tool according to claim 1, wherein the drive mechanism is configured to operate in a high torque mode, in which the first and second motors are operated concurrently in the same direction to generate a high torque output.

13. The torque tool according to claim 1, wherein the drive mechanism is configured to operate in a super low torque mode, in which the first and second motors are operated concurrently at the same time in opposing directions to generate a super low torque output.

14. (canceled)

15. The torque tool according to claim 2, wherein the drive mechanism comprises a hydraulic motor interface device comprising:
a first interface surface on one side of the device configured to couple a hydraulic fluid supply to the first motor, and
a second interface surface on an opposing side of the device configured to couple a hydraulic fluid supply to the second motor.

16. The torque tool according to claim 15, wherein the first and/or second interface surface are substantially planar.

17. The torque tool according to claim 15 wherein the first and/or second interface surface comprises one or more grooves to fluidly couple with the first and/or second hydraulic motors.

18. The torque tool according to claim 2, wherein the drive mechanism comprises a hydraulic motor interface device comprising a plurality of radial ports fluidly connected with one or more grooves to fluidly couple with the first and/or second hydraulic motors.

19. The torque tool according to claim 1, wherein the drive mechanism comprises a hydraulic motor interface device, and wherein the common drive shaft extends through the hydraulic motor interface device.

20. The torque tool according to claim 1, wherein the drive mechanism comprises at least one transfer plate configured to control the flow of hydraulic fluid into and out from the motors.

21. The torque tool according to claim 20, wherein the drive mechanism comprises a hydraulic motor interface device and a transfer plate located between the hydraulic motor interface device and each motor.

22. The torque tool according to claim 20, wherein the or each transfer plate comprises an inner arrangement of channels and/or an outer arrangement of channels, and wherein the or each transfer plate is configured such that the hydraulic fluid enters the motor via the inner arrangement of channels and exits the motor via the outer arrangement of channels.

23. (canceled)

24. The torque tool according to claim 20, wherein the or each transfer plate comprises an inner arrangement of channels and/or an outer arrangement of channels, and wherein the transfer plate is configured such that the hydraulic fluid enters the motor via the outer arrangement of channels and exits the motor via the inner arrangement of channels.

25. The torque tool according to claim 20, wherein the common drive shaft extends through the or each transfer plate.

26. The torque tool according to claim 2, comprising a drainage path for at least one of the first or second hydraulic motors, wherein the drainage path is configured to enable hydraulic fluid from a disengaged hydraulic motor to be drained when the other of the hydraulic motors is operable.

27.-29. (canceled)

30. The torque tool according to claim 2, wherein the torque tool comprises a pilot relief manifold block operable to control drainage of hydraulic fluid from a disengaged motor to a hydraulic return line.

31. (canceled)

32. The torque tool according to claim 1, wherein the hydraulic motor interface device has an axial dimension in the direction of the drive shaft of less than approximately 100 mm.

33. The torque tool according to claim 32, wherein the hydraulic motor interface device has an axial dimension in the direction of the drive shaft of less than approximately 40 mm.

34. A motor assembly for a torque tool, the motor assembly comprising:
a first motor having a first torque output and a second motor having a second torque output; wherein the first and second motors are operable to drive a common drive shaft.

35.-37. (canceled)

38. A method of operating a torque tool comprising:
providing a torque tool, the torque tool comprising:
at least one torque drive head and a drive mechanism operable to rotate the at least one torque drive head; and
a first motor having a first torque output and a second motor having a second torque output; and
operating the first and/or second motors to drive a common drive shaft.

39. The method according to claim 38, comprising operating the first and/or second motor to rotate in a clockwise direction and/or an anticlockwise direction.

40. The method according to claim 38, comprising operating the first and second motors to rotate in the same direction.

41. The method according to claim 38, comprising operating the first and second motors to rotate in opposing directions.

42. The method according to claim 38, comprising operating the drive mechanism in a low torque mode, in which only the first motor is operated to generate a low torque output.

43. The method according to claim 38, comprising operating the drive mechanism in a medium torque mode, in which only the second motor is operated to generate a medium torque output.

44. The method according to claim 38, comprising operating the drive mechanism in a high torque mode, in which the first and second motors are operated concurrently in the same direction to generate a high torque output.

45. The method according to claim 38, comprising operating the drive mechanism in a super low torque mode, in which the first and second motors are operated concurrently at the same time in opposing directions to generate a super low torque output.

46. The method according to claim 38, wherein the first and second motors are hydraulic motors, and the method comprises draining hydraulic fluid from a de-activated hydraulic motor when the other hydraulic motor is activated.

47. (canceled)

48. A subsea vehicle system comprising the torque tool according to claim 1.

49. The subsea vehicle system of claim 48, wherein the subsea vehicle is a Remotely Operated Vehicle (ROV).

50.-52. (canceled)
